(19) United States
(12) Patent Application Publication
(10) Pub. No.: US 2006/0184398 A1
(43) Pub. Date: Aug. 17, 2006

(54) Card reservation settlement system by acceptance via telephone and card reservation settlement method

(76) Inventor: Hidejiro Kasagi, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/316,844

(22) Filed: Dec. 27, 2005

Related U.S. Application Data
(63) Continuation-in-part of application No. PCT/JP04/06841, filed on May 20, 2004.

(30) Foreign Application Priority Data
May 21, 2003 (JP) 2003-143166
Aug. 5, 2003 (JP) 2003-287044
Oct. 23, 2003 (JP) 2003-362727
Feb. 12, 2004 (JP) 2004-034887

(51) Int. Cl. G06Q 99/00; G06Q 10/00

(52) U.S. Cl. 705/5; 705/1

(57) ABSTRACT

A card reservation settlement system via telephone acceptance for card settlement in travel, teleshopping, and other telephone reservation. The system is characterized by including: reservation reception means of a reservation receiver and the like receiving a reservation made by a reservation transmitter; card information transmission means for transmitting information required for a card settlement to a card company; crosscheck response means of the card company; and reservation completion means of the card company.

### TECHNICAL FIELD

The invention relates to a card reservation settlement system by acceptance via telephone and a card reservation settlement method intended to prevent leak of personal information of card and to settle card reservation when transmitting a desired card reservation to a reservation agent or reservation operator from mobile telephone or installed telephone.

### BACKGROUND ART

Hitherto, when reserving by telephone, the client discloses the card number and other information to the reservation agent, the reservation agents confirms with the card company on the basis of the personal information, and negotiates with the service provider and completes the reservation.

The before described conventional art is disclosed in the prior atr, such as unexamined Japanese Patent Publication No. JP-A-2001-243503, for example.

### DISCLOSURE OF THE INVENTION

According to conventional card reservation and settlement, personal information of card is replied to the reservation agent, and personal information of card may be leaked to third party by way of the reservation agent.

The invention has solved the problems of the prior art by allowing the client to enter the personal information of card by phone or by voice directly to the card company without involving third party, or allowing the card company to issue a customer invoice number instead of card number after authenticating input in CAFIS or AP, or encrypting the transmission data from the reservation transmitter.

Accordingly, in the case of card settlement of telephone reservation of travel or shopping, the invention provides a card reservation settlement system by acceptance via telephone comprising reservation receiving means of a reservation receiver and the like receiving a reservation made by a reservation transmitter, card information transmission means for transmitting information required for a card settlement to a card company, and inquire response means of the card company and reservation completion means, in which the card information transmission means is characterized by allowing the reservation receiver to make the reservation transmitter and its card company or CAFIS to communicate directly with each other.

In other aspect of the invention, the card information transmission means is characterized by masking the card information automatically at the time of input, and erasing the tone sound of card information automatically so as not to be heard by the operator.

In other aspect of the invention, the card information transmission means is characterized by encrypting card information, transmitting to the card company, decoding and verifying the information at the card company, and transmitting the result information to the reservation receiver, and the inquire response means is characterized by evaluating the card payment capability on the basis of personal information of card, and replying approval or rejection.

In other aspect of the invention, the reservation response means is characterized by allowing the reservation receiver to transmit completion of reservation to the reservation transmitter after detecting approval or rejection of card settlement, and the telephone may be either mobile telephone or installed telephone.

In other aspect of the invention, the inquire response means is characterized by evaluating the card payment capability on the basis of personal information of card, and replying approval or rejection, and allowing the reservation transmitter to issue the own invoice number of the reservation receiver from the card company in place of card number.

A different aspect of the invention is a card reservation settlement method relating to a case of reserving a hotel and settling the lodging expenses by card, in which the guest informs the hotel operator of card settlement from the hotel room, the operator transmits card information of the guest to the card company without intervention, inquiring to card company, and settles card payment by requesting accounting of lodging expenses to the counter when card settlement approval response is obtained from the card company, and the payment statement and receipt are issued when the guest returns the room key.

Herein, while the reservation agent is directly communicating with the transmitter and the card company, card information never leaks to the reservation agent or other.

However, if the transfer portion of the reservation agent can be received together with the transfer content, the content is received in the reservation agent simultaneously with transfer. To avoid such inconvenience, personal information of card is encrypted and transmitted to the card company, so that the card company decodes, and verifies or processes as required.

Reservation content in the invention can be applied to reservations to be settled by card or mail-order services of commodities.

As described herein, the invention is characterized by authorization of card number and valid term without intervention of third party, and in card settlement via telephone, the operator changes over to the IVR (interactive voice response), and the client oneself can enter the card number or valid term directly by telephone or voice.

It is hence applied to all reservations settled by card allowing the client who desires reservation to reserve to agent or order purchase of goods by mobile telephone or the like.

Individual recognition in the mail order or card company is conducted by comparing the password, secret number, ID number, voice (or voice print), portrait, fingerprint, palm print, iris, or signature with the registered data determined (collected) at the time of application.

Herein, the infrastructure of network for approval is CAFIS (NTT Data), but not limited to CAFIS, it can be applied in other infrastructures, such as VISAGP Net (VISA Group), JCN (Japan Card Network, JCB), and MN (Master Net, Master Card).

According to the invention, by reserving from mobile telephone or the like, payment can be settled by card, and card information of the reservation transmitter is transmitted only to the card company, and thereby preventing card information from being leaked to third party.

When the card company issues a specific invoice number to the reservation receiver (client), transaction is conducted with the invoice number with the card member store (mail order sales company). In other words, since the invoice number is used instead of card number, the card number is not disclosed to the card member store, and hence the card number is not leaked to third party.

When reserving a hotel room by card, the lodging expenses can be settled by card from the hotel room by way of the operator.

### BRIEF DESCRIPTION OF THE DRAWINGS

FIG. 1 is a block diagram of the first example of the invention.

FIG. 2 is a block diagram of the second example of the invention.

FIG. 3 is a block diagram of the third example of the invention.

FIG. 4 is a block diagram of the fourth example of the invention using CAFIS.

FIG. 5 is a block diagram of the fourth example of the invention showing image of using card number input system using IVR.

FIG. 6 is a block diagram of the fifth example of the invention using invoice number.

FIG. 7 is a block diagram of the sixth example of the invention.

FIG. 8 is an explanatory diagram of the sixth example of the invention showing card number display in FIG. 7.

FIG. 9 is a block diagram of the seventh example of the invention using card settlement from hotel room.

FIG. 10 is an explanatory diagram of purchase of ticket.

FIG. 11 is an explanatory diagram of order by telephone.

FIG. 12 is an explanatory diagram of order by facsimile.

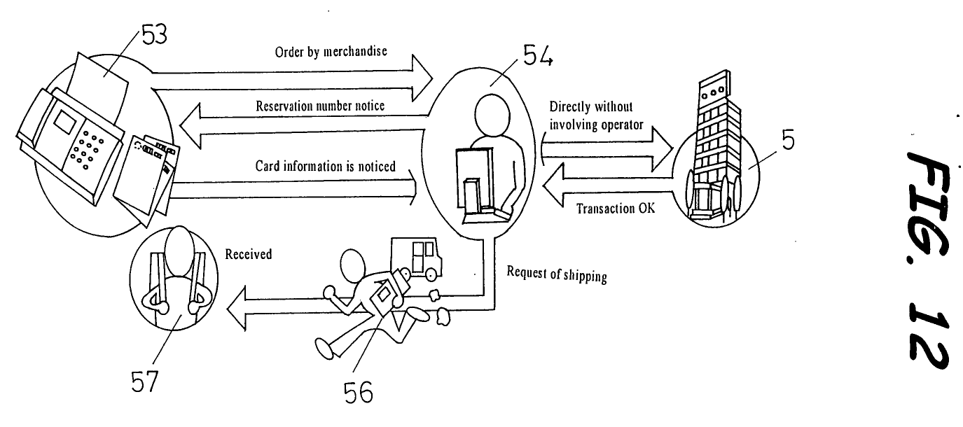

FIG. 13 is an explanatory diagram of reservation of travel.

### REFERENCE NUMERALS

1 Reservation transmitter
2 Mobile telephone
3 Reservation agent
3a Mail order sales company
4 Reception (plain text)
4a Reception (encrypted)
5 Card company
6 Reservation destination
6a Distributor
7 CAFIS
8 Banking institution

### BEST MODE FOR CARRYING OUT THE INVENTION

According to the invention, when a reservation transmitter (applicant) applies reservation by mobile telephone or the like, the reservation agent connects with the card company on line, and the reservation transmitter can directly transmit the card information to the card company.

The card company checks the personal information of the card, and investigates the ability to pay, for example, and reports the result to the reservation agent, and the reservation agent can file reservation, and transmits the result to the reservation transmitter upon completion.

### EXAMPLE 1

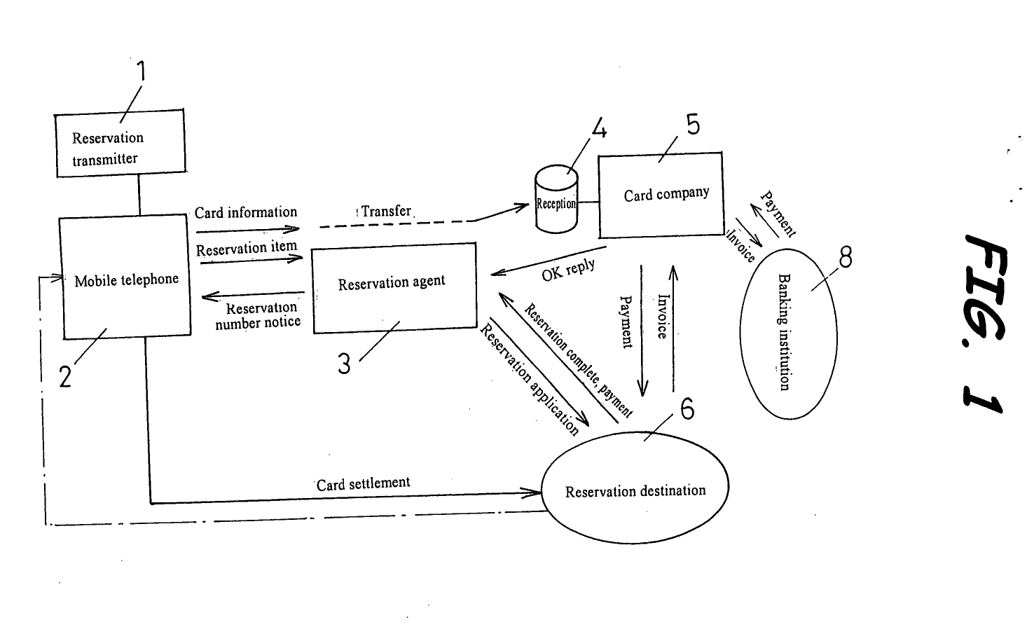

An embodiment of the invention is explained by referring to FIG. 1. A reservation transmitter 1 transmits necessary reservation items to a reservation agent 3 by using a mobile telephone 2. The reservation agent 3 acquires the name of subscribed card company 5 from the reservation transmitter 1, and directly links the reservation transmitter 1 and the card company 5, so that all necessary card information may be directly transmitted to the card company 5. When the card company 5 receives 4, personal information of card will not be leaked to the reservation agent 3. The card company 5 investigates the creditability of the card of the reservation transmitter 1, and reports the result (whether the card is valid or not) to the reservation agent 3.

In this operation, the reservation agent 3 receiving the card validity notice completes necessary reservation at desired reservation destination 6, and reports the result to the reservation transmitter 1. If reservation charge is needed, the reservation destination 6 requests payment by card to the card company 5, and after receiving the payment, pays necessary reservation commission to the reservation agent 3, and completes the reservation settlement.

In the case of commodity sales company, the reservation destination 6 ships the reserved commodity to the reservation transmitter 1 simultaneously with card settlement, and terminates the transaction.

In the case of hotel room reservation or the like to be paid later, the reservation charge is subtracted from the boarding expense, and the balance is invoiced to the card company, and necessary payment is received from the card company 5.

The card company 5 draws the necessary amount (the amount spent by the reservation transmitter) from the deposit of the reservation transmitter 1 according to the contract, and remit payment to the hotel or reservation destination 6 after subtracting the reservation commission, which is same as in ordinary settlement by card.

As stated above, the card information of reservation transmitter 1 is directly transmitted between the reservation transmitter (applicant) 1 and the card company 5, and is hence protected. This embodiment is realized by switching of the line by the operator of the reservation agent 3.

Herein, the financial settlement is done automatically between the card company 5 and banking institution 8, and is hence same as in ordinary settlement by card.

### EXAMPLE 2

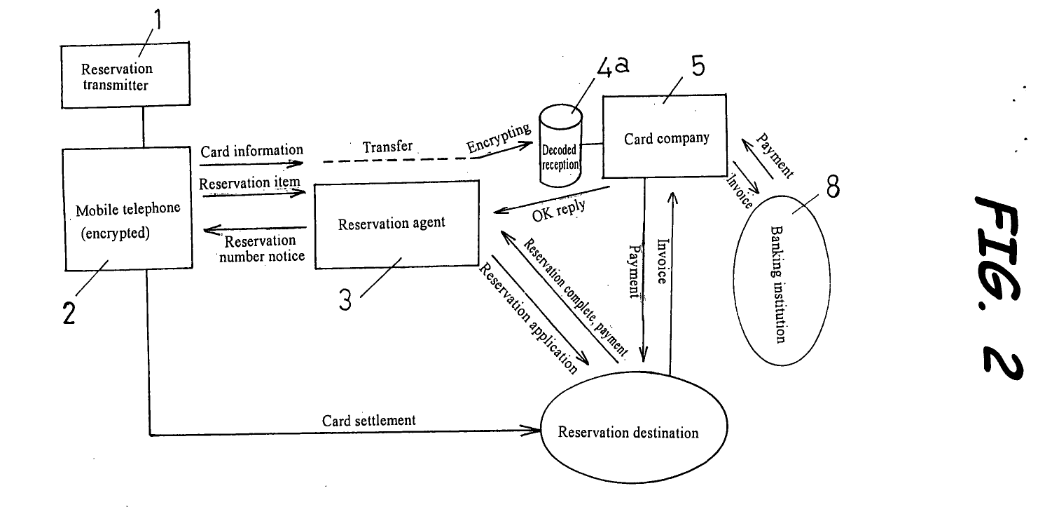

Other embodiment of the invention is explained by referring to FIG. 2. In embodiment 1, communication between the reservation transmitter 1 and card company 5 is made in plain text, and information may be leaked to third party, but from the viewpoint of protection of personal information, card information of reservation transmitter 1 is encrypted, and decoded by the card company, and received 4a, and in this system, incidental leak of card information to third party in the process of reservation can be prevented.

This object can be achieved by incorporating encrypting software in the telephone set of reservation transmitter 1 and incorporating decoding software in the receiver 4a of the card company 5.

In this case, it does not function unless encrypting and decoding software is installed in the telephone set 2 of the reservation transmitter 1 and the receiver 4a of the card company 5.

Otherwise if the reservation transmitter 1 transmits encrypted statement, the object is achieved only by decoding at the receiving side.

Herein, payment by card settlement is done between the card company 5 and banking institution 8 in the same way as in ordinary invoice and pay transaction, and is hence same as in other ordinary settlement by card.

### EXAMPLE 3

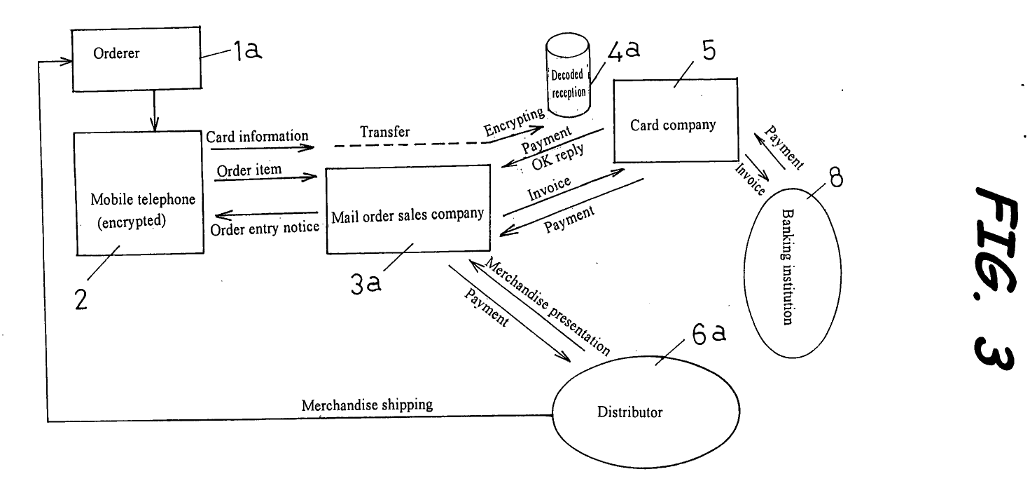

Another embodiment (mail order sales of commodity) of the invention is explained by referring to FIG. 3.

A orderer la orders a desired commodity to a mail order sales company 3a by mobile telephone 1, and the mail order sales company 3a reports to the card company 5, and puts the orderer la and card company 5 in direct communication state, and the orderer la informs the card company 5 of card information. In this case, the orderer la encrypts and transmits the communication message, and the card company 5 decodes and receives 4a. The card company 5 investigates the creditability of the card (paying capability), and sends an OK response to the mail order sales company 3a if creditable.

The mail order sales company 3a requests shipping of commodity to distributor 6a, and pays necessary amount. Order acceptance and shipping schedule are reported to the orderer la. The mail order sales company 3a transfers the ordered commodity to the orderer la, and completes mail order sales.

In this financial settlement, the mail order sales company 3a invoices to the card company 5, the card company 5 pays the mail order sales company 3a, and invoice and pay transaction is made between the card company 5 and banking institution 8 which is the same as in ordinary settlement by card.

### EXAMPLE 4

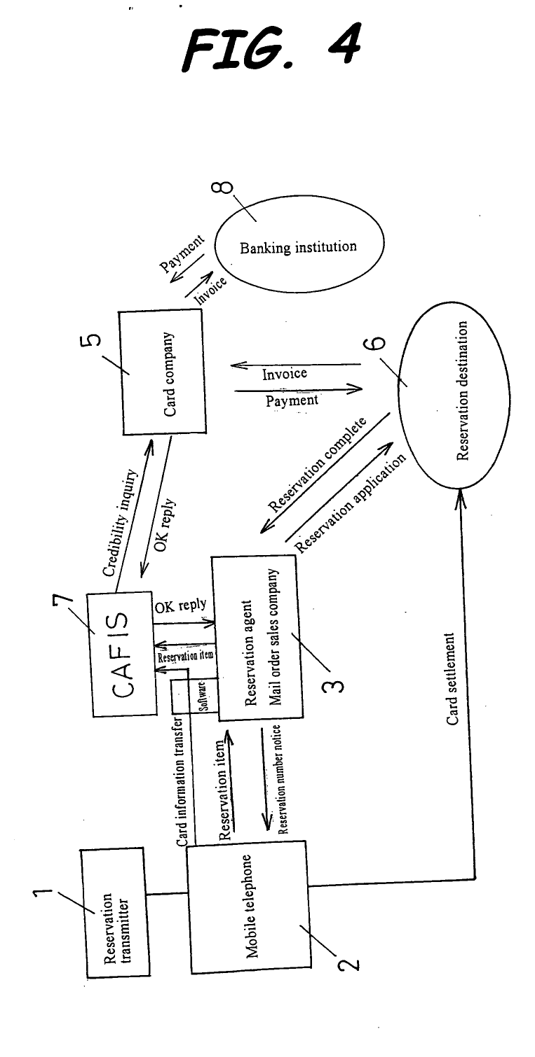

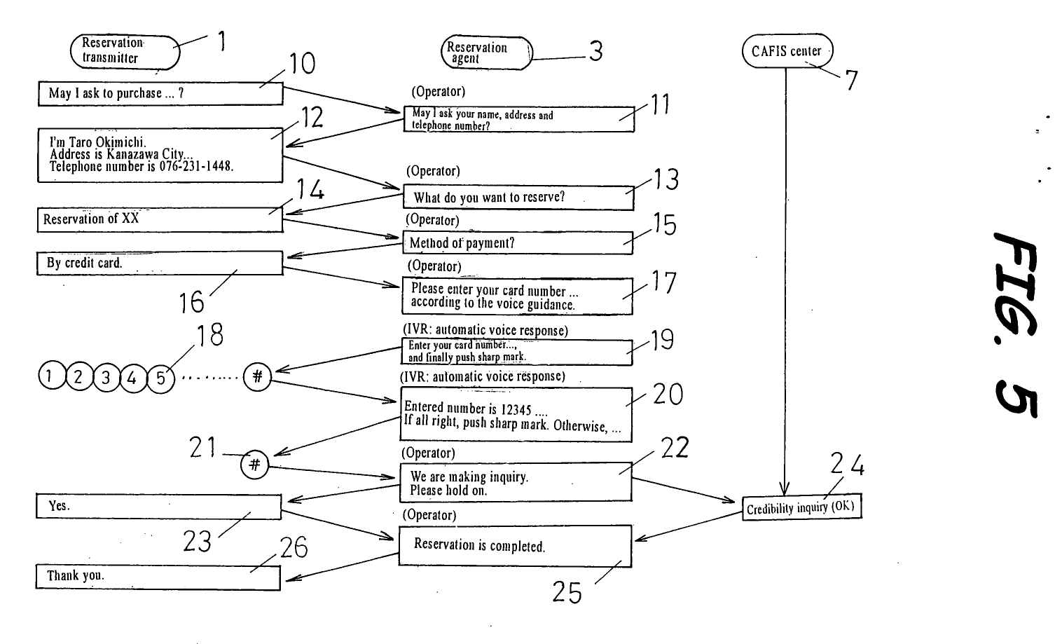

Another embodiment (reservation system) of the invention is explained by referring to FIGS. 4 and 5. This embodiment is card settlement transaction via CAFIS.

A reservation transmitter 1 transmits necessary reservation items to a reservation agent 3 by mobile telephone 2 (or installed telephone). The reservation agent 3 has CAFIS 7 connected to the subscribed card company 5 of the reservation transmitter 1, and transmits the card information directly to the CAFIS 7. In this case, usual card information (age, sex, name, etc.) can be transmitted from the reservation agent 3 to the CAFIS 7.

However, the software of the reservation agent is direct (IVR) or masked so that confidential information of the card such as card number and password may be directly transmitted from the reservation transmitter 1 to the CAFIS 7, and the reservation agent 3 is interrupted (direct communication). Hence, leak of personal information is prevented.

Creditability is inquired from CAFIS 7 to card company 5, and when the card company 5 replies OK to the reservation agent 3 via CAFIS 7, the reservation agent 3 makes reservation to reservation destination, and reservation is completed. The card company 5 receives a reservation bill from the reservation destination 6, and invoices to banking institution 8, and receives necessary payment, and conducts card settlement with the reservation destination 6.

An example of use of card number input system by IVR (interactive voice response) is explained in FIG. 5. When the reservation transmitter 1 desires to reserve XX, and applies XX reservation 10 to reservation agent 3 by mobile telephone, the operator asks name, address, and contact information 11, and the reservation transmitter replies 12. Then the operator asks reservation detail 13, and the reservation transmitter replies 14 as XX reservation. The operator asks method of payment 15, and the reservation transmitter replies 16 as card settlement. The operator changes over to IVR (preset machine voice instructs input in place of operator), and card number 18 is entered, and end signal 19 is entered according to instruction. Card number is repeated by automatic input voice (machine voice), when OK sign 21 is pressed, the line is switched to the operator, and waiting 22 is asked, and when acceptance 23 is obtained, the CAFIS 7 inquires 24 the card company, and OK reply 24 is sent from the card company to CAFIS 7, and completion of reservation 25 is reported, and confirmed 26, and the reservation is completed.

Thus, the card number 18 is supplied into the CAFIS 7 without involving the operator, and confidential information is protected.

This is the procedure of transaction between the reservation transmitter (card member) 1 and reservation agent with the aid of CAFIS 7, and same procedure can be applied to purchase of commodities.

### EXAMPLE 5

A different embodiment of the invention is explained in FIG. 5. This embodiment is transaction of card settlement by way of CAFIS.

A reservation transmitter 1 transmits necessary reservation items to a reservation agent 3 by mobile telephone 2 (or installed telephone). The reservation agent 3 has CAFIS 7 connected to the subscribed card company 5 of the reservation transmitter 1, and transmits the card information directly to the CAFIS 7. In this case, usual card information (age, sex, name, etc.) can be transmitted from the reservation agent 3 to the CAFIS 7.

However, the software of the reservation agent is designed to communicate directly so that confidential information of the card such as card number and password may be directly transmitted from the reservation transmitter 1 to the CAFIS 7 (without involving third party), and the reservation agent 3 is not aware (direct communication). Hence, leak of personal information is prevented.

Creditability is inquired from CAFIS 7 to card company 5, and when the card company replies OK to the reservation agent 3 via CAFIS, the reservation agent 3 makes reservation to reservation destination, and reservation is completed. The card company 5 receives a reservation bill from the reservation destination 6, and invoices to banking institution 8, and receives necessary payment, and terminates card settlement with the reservation destination 6.

An example of use of card number input system by IVR (interactive voice response) is explained in FIG. 5. When the reservation transmitter 1 desires to reserve XX, and applies XX reservation 10 to reservation agent 3 by mobile telephone, the operator asks name, address, and contact information 11, and the reservation transmitter replies 12. Then the operator asks reservation detail 13, and the reservation transmitter replies 14 as XX reservation. The operator asks method of payment 15, and the reservation transmitter replies 16 as card settlement. The operator changes over to IVR, and machine voice urges input 17. The reservation transmitter 1 enters card number 18, and enters end signal 19 according to instruction. Card number 20 is repeated by automatic input voice (machine voice), when OK sign 21 is pressed, the line is switched to the operator, and waiting 22 is asked, and when acceptance 23 is obtained, the CAFIS 7 is inquired 24, and OK reply 24 is obtained from CAFIS 7.

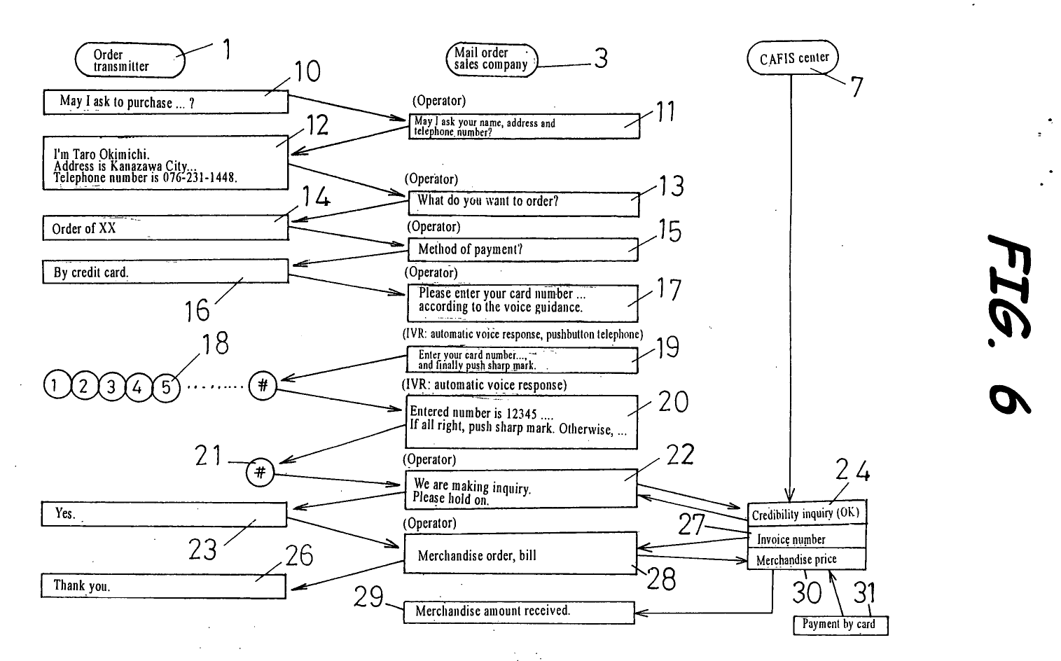

In the case of OK, the card company reports invoice number 27 of the orderer to the reservation agent 3. The reservation agent 3 orders the commodity, and invoices 28 to the card company, receives payment for commodity, and the transaction is terminated when the amount is received 29 (FIG. 6).

The commodity price 30 is received by card 31 from the banking institution. This embodiment is characterized by using invoice number in addition to card number.

### EXAMPLE 6

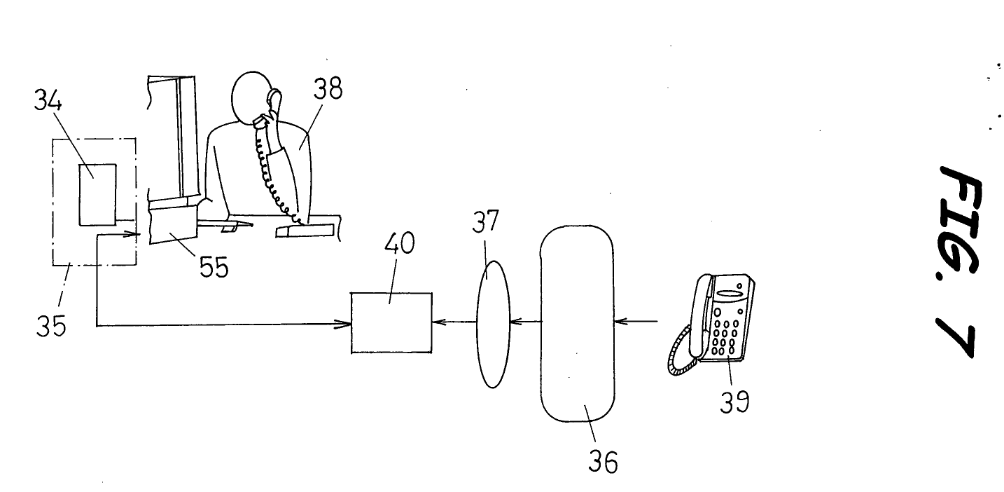

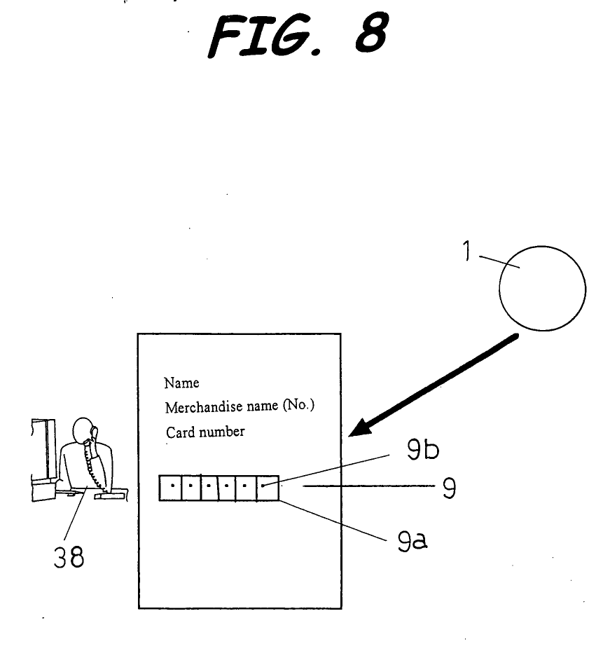

An embodiment of masking card information in the invention is explained in FIGS. 7 and 8. In order that the card information may not be leaked to the operator, only the card information may be transmitted directly, or the card information may be encrypted.

In the card information masking method, if the card information detail (card number) is not known, it can be detected whether card number of plural digits is transmitted or not.

FIG. 7 explains a case of using VOIP (voice over IP protocol) of CTI (computer telephony integration) 40, in which the reservation transmitter enters by pushbutton 39 of telephone, and the information reaches an operator 38 through CTI 40 from extension 37 via PBX 36. In this case, the input is directly entered in a personal computer 55 by passing through tone eliminating filter 34 or eliminating tone by CTI 40.

The operator 38 tells the reservation transmitter to send the card number. In this case, the card number is masked to conceal the number display column 9a and is displayed as transmission mark 9b as shown in screen 9 in FIG. 8. Thus the operator 38 can monitor only whether the necessary number of digits is transmitted or not. Transmission sound is also masked for the operator 38. This is to prevent interpretation of original transmission sound of numerals.

When the card number is transmitted, the operator 38 inquires the card company, and the card company replies the operator 38 whether the card is valid or not, and when the card is valid, the operator 38 transmits the name of reservation transmitter, merchandise name, and card number (masked) to the reservation destination.

As for card settlement, the operator 38 settles the card payment by ordinary procedure.

### EXAMPLE 7

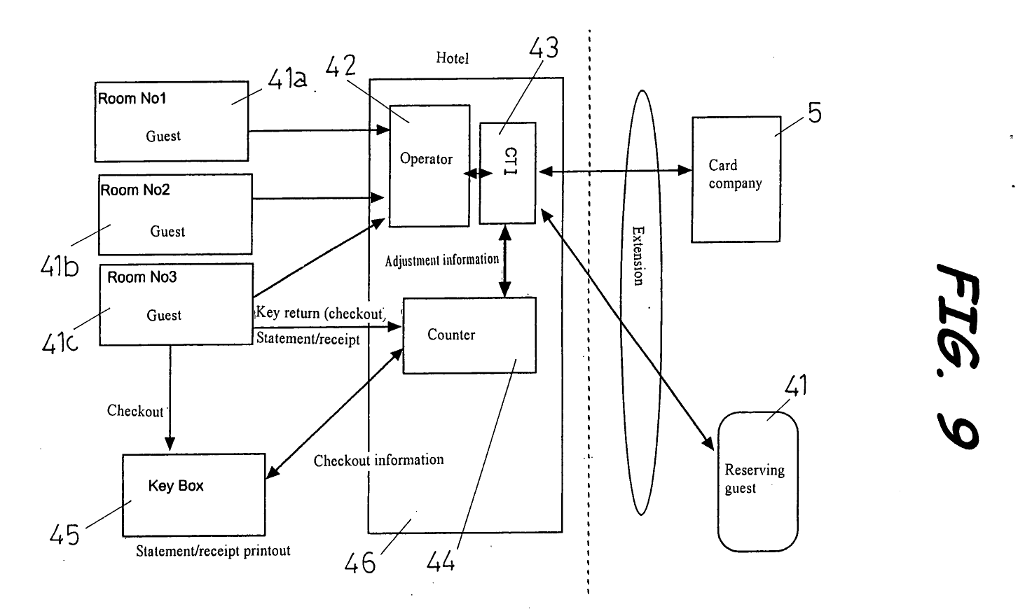

Adjustment of lodging expenses of hotel 46 from hotel room in the invention is explained in FIG. 9. For example, when guest 41a of room No. 1 desires adjustment of lodging expenses, adjustment of lodging expenses of room No. 1 is told to the hotel operator 42. The hotel operator 42 refers to reservation record (CTI) 43 of reservation transmitter 41 (same as guest) (or directly transmits the card number to the card company), and creditability of the guest 41a is confirmed from the card company 5, and request adjustment of boarding expense to the counter 44. The same procedure is applied to guests 41b and 41c in rooms No. 2 and No. 3.

To inquiry from the operator 42, when payment OK information is obtained from the card company 5, the card settlement is executed in ordinary procedure, and the statement and receipt are issued, and preserved at the counter 44. When the guest 41a returns the room key, the statement and receipt are handed over, or when the key is put in the key box 45, the statement and receipt are issued automatically.

In this manner, the checkout crowd at the counter (disturbance in clerical works) can be avoided.

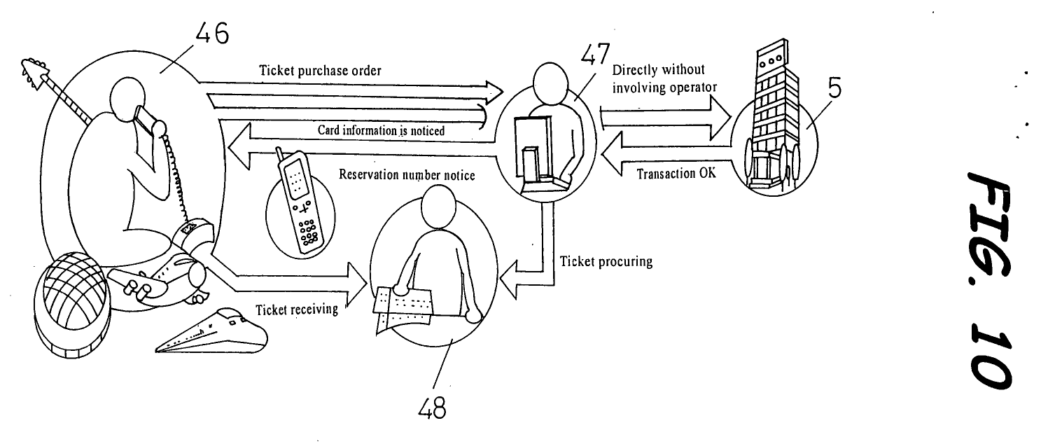

A further embodiment of the invention is explained in FIG. 10, in which a purchaser 46 intends to purchase a ticket by sending card information of the card company 5 through agent 47 (transmitting through agent) by using telephone (or mobile telephone). The agent 47, after the card information is noticed, inquires the card company 5, receives transaction OK reply of the card, and orders the ticket, notices a reservation number to the purchaser 46, and settles by card. The purchaser 46 receives the ticket at ticket counter 48. In the case of mobile telephone, an electronic ticket may be utilized by showing reservation number by short mail.

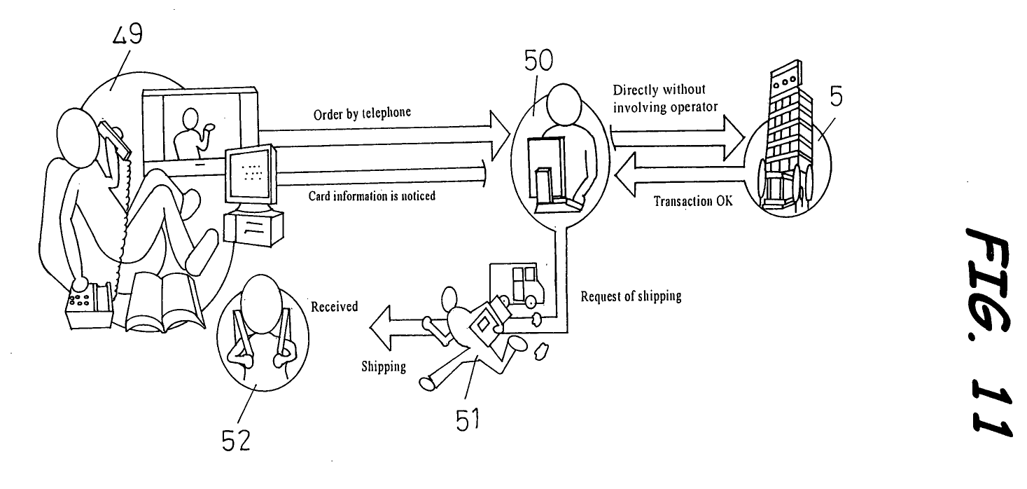

Telephone settlement of TV, catalog and web is explained in FIG. 11. A telephone orderer 49 calls on-line shop 50, and tells purchase of commodity on the basis of TV information or the like, and sends card information. In this case, the card information is transmitted through the on-line shop 50, but is not displayed and transmitted directly to the card company 5.

The on-line shop 50 confirms the card creditability of purchaser with the card company, and if transition is OK, requests a shipping agent 51 to deliver the ordered merchandise to the orderer 52. In this case, the payment is settled in the same way as in ordinary card settlement.

When ordering a commodity by post or facsimile, order confirmation is given by telephone from shop operator 54, and card information is noticed to the card company without help of operator 54. The operator requests credibility investigation of orderer to the card company 5, and on the basis of transaction OK notice, and shipping of merchandise is requested to shipping agent 56, and the orderer 57 receives the merchandise.

In this case, the payment is settled in the same way as in ordinary card settlement.

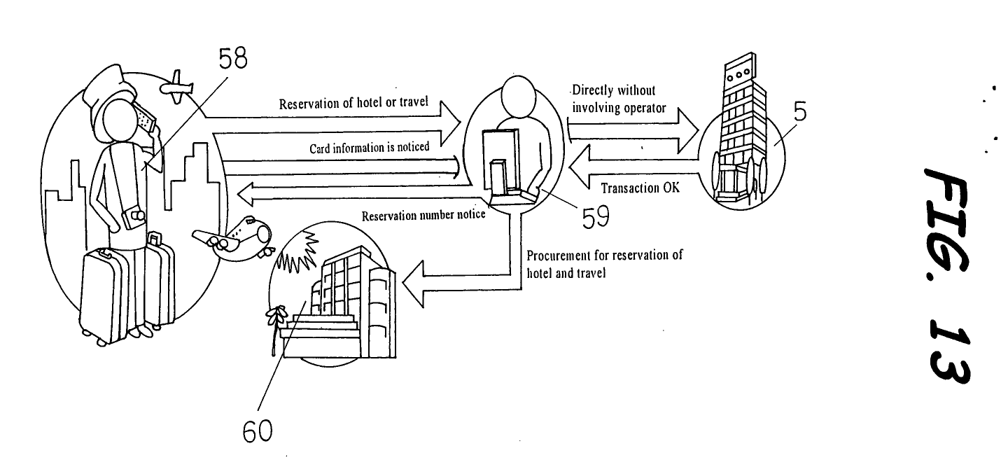

When reserving hotel or travel, as shown in FIG. 13, a traveler 58 rings a travel agency 59, and transfers card information to card company 59 without relaying operator of travel agency. The operator requests credibility investigation to the card company 5, and on the basis of transaction OK notice, and reserves hotel 60 and airline ticket and others for travel, notices reservation number to the traveler 58, and settles by card as usual.

The preferred embodiment and examples of the invention have been described with reference to the accompanying drawings. However, the invention is not limited to these embodiment and examples, but can be modified in various embodiments and examples within the technical scope grasped from the appended claims.

1. A card reservation settlement system by acceptance via telephone in card settlement of reservation of travel, mail order sales and others by telephone, comprising reservation receiving means of a reservation receiver and the like receiving a reservation made by a reservation transmitter, card information transmission means for transmitting information required for a card settlement to a card company, and inquire response means of the card company and reservation completion means.

2. The card reservation settlement system by acceptance via telephone of claim 1, wherein the card information transmission means is characterized by allowing the reservation receiver to make the reservation transmitter and its card company or CAFIS to communicate directly with each other.

3. The card reservation settlement system by acceptance via telephone of claim 1, wherein the card information transmission means is characterized by masking the card information automatically at the time of input, and erasing the tone sound of card information automatically so as not to be heard by the operator.

4. The card reservation settlement system by acceptance via telephone of claim 1, wherein the card information transmission means is characterized by encrypting card information, transmitting to the card company, decoding and verifying the information at the card company, and transmitting the result information to the reservation receiver.

5. The card reservation settlement system by acceptance via telephone of claim 1, wherein the inquire response means is characterized by evaluating the card payment capability on the basis of personal information of card, and replying approval or rejection.

6. The card reservation settlement system by acceptance via telephone of claim 1, wherein the reservation response means is characterized by allowing the reservation receiver to transmit completion of reservation to the reservation transmitter after detecting approval or rejection of card settlement.

7. The card reservation settlement system by acceptance via telephone of claim 1, wherein the inquire response means is characterized by evaluating the card payment capability on the basis of personal information of card, and replying approval or rejection, and allowing the reservation transmitter to issue the own invoice number of the reservation receiver from the card company in place of card number.

8. The card reservation settlement system by acceptance via telephone of claim 1, wherein the telephone may be either mobile telephone or installed telephone.

9. A card reservation settlement method relating to a case of reserving a hotel and settling the lodging expenses by card, wherein the guest informs the hotel operator of card settlement from the hotel room, the operator transmits card information of the guest to the card company without intervention, inquiring to card company, and settles card payment by requesting accounting of lodging expenses to the counter when card settlement approval response is obtained from the card company, and the payment statement and receipt are issued when the guest returns the room key.
